(19) United States
(12) Patent Application Publication
(10) Pub. No.: US 2018/0068770 A1
(43) Pub. Date: Mar. 8, 2018

(54) COMPOSITE MAGNETIC MATERIAL, COMPOSITE MAGNETIC MOLDED BODY, ELECTRONIC COMPONENT, AND METHOD THEREOF

(71) Applicant: SUMIDA CORPORATION, Tokyo (JP)

(72) Inventors: Mitsugu KAWARAI, Natori City (JP); Kazuhisa SATO, Natori City (JP)

(21) Appl. No.: 15/687,685

(22) Filed: Aug. 28, 2017

(30) Foreign Application Priority Data
Sep. 8, 2016 (JP) 2016-175840

(51) Int. Cl. H01F 1/20; H01F 27/255; H01F 27/28; H01F 41/02

(52) U.S. Cl. CPC H01F 1/20; H01F 41/0246; H01F 27/28; H01F 27/255

(57) ABSTRACT

A composite magnetic material includes a metal magnetic powder, a binder resin, and a metallic soap. A melting point of the organic metallic soap is equal to or lower than a thermosetting temperature of the binder resin. The organic metallic soap and the binder completely cover an entire surface of the metal magnetic powder. Further, 0.01 wt %<(wt % of the organic metallic soap)/(wt % of the organic metallic soap+wt % of the metal magnetic powder+wt % of the binder resin)×100<2.0 wt %.

### CROSS-REFERENCE TO RELATED APPLICATION

This application claims priority to Japanese Patent Application No. 2016-175840 filed Sep. 8, 2016 which is hereby expressly incorporated by reference herein in its entirety.

### BACKGROUND

### Technical Field

The present invention relates to a composite magnetic material, a composite magnetic molded body that is obtained by heat curing (thermally curing) the composite magnetic material, an electronic component that is obtained by using the composite magnetic molded body, and a method thereof.

### Related Art

It is known that a metal magnetic powder and a thermosetting resin as a binder resin can be mixed to form a mixed material. Thereafter, the mixed material may be molded and then thermally cured to form a composite magnetic heat-cured body (a composite magnetic cured body or a composite magnetic thermoset body). An electronic component, in which the composite magnetic heat-cured body and a coil that is formed by winding a wire having an insulating layer thereon are assembled, requires a variety of reliabilities.

As a conventional method relating to the above technology, for instance, the following method is disclosed in Japanese Patent Publication No. 2009-0088502. A method for manufacturing an oxide-coated soft magnetic powder includes first and second processes. A primary particle is obtained in the first process. Specifically, the primary particle is composed of Fe as a main component and a soft magnetic material as an accessory component that is the second highest component present following Fe. Further, the soft magnetic material includes at least one of Si, Al and Cr. A surface of the primary particle is covered with an oxide layer that includes an iron oxide. In the second process, a secondary particle is obtained based on the primary particle. Specifically, by applying a heat treatment to the primary particle in an inert atmosphere, at least a part of the iron oxide in the oxide layer is reduced (deoxidized), and at the same time, an oxide of the accessory component is generated in the oxide layer. Further, in Japanese Patent Publication No. 2009-0088502, the oxide-coated soft magnetic powder that is manufactured by the method explained above, a powder magnetic core, and a magnetic element are described. Specifically, after a molded body is obtained by pressurizing and molding a mixture of the oxide-coated soft magnetic powder and a binder resin, the powder magnetic core is obtained by curing the binder resin in the molded body. The magnetic element has the powder magnetic core. Further, the method for manufacturing the oxide-coated soft magnetic powder that can manufacture the powder magnetic core at a low cost can be provided. Because the powder magnetic core is covered with the highly insulating oxide, the powder magnetic core has a small amount of eddy current loss over a long period of time and has high permeability. It is also described that the oxide-coated soft magnetic powder that is manufactured by the method explained above, the powder magnetic core that has the high permeability and a low loss and that is manufactured by using this oxide-coated soft magnetic powder, and a high performance magnetic element that has this powder magnetic core can be provided.

The electronic component in which the metal magnetic powder explained above is used is particularly highly recommended to have a rust prevention performance in which rust is not generated even when a salt water spray test is carried out.

Here, originally, the metal magnetic powder is equally coated with a thermosetting resin which is a binder, and as a result, a reliable rust prevention performance is expected. However, because it is actually difficult to completely make wettability between a surface of the oxidized metal magnetic powder and the thermosetting resin as the binder correspond, the surface of the metal magnetic powder cannot be completely coated with thermosetting resin as the binder. Therefore, methods of reforming the surface of the metal magnetic powder with a coupling agent or improving the wettability by adding a dispersant have been considered and implemented.

Further, in order to enhance the rust prevention performance, a resin coating and a coating (such as a CVD coating or a fluorine coating) of electronic component products are performed at the present time. However, there are problems of a high material cost and a high machining cost, and a technical problem in which the coating is needed but must avoid an electrode portion of an electronic component.

However, the rust prevention performance that withstands the salt water spray test cannot actually be obtained by the conventional method explained above. The investigation and analysis of the cause of this by the inventors of the present invention reached a conclusion that a part that is not coated with the binder still exists because of the physical nature and chemical property of the surface of the metal magnetic powder so that in the salt water spray test, rust is generated on the metal magnetic powder at this part, or rust invades and spreads from this part to a lower layer of the coated part. Further, the inventors of the present invention also discovered that the part that was not coated with the binder was actually coated when being mixed with the binder, however, rust can be generated because the coating film is scraped away by friction with a mold at the time of molding (before a heat curing) or friction between the molded bodies during transportation of the molded bodies.

### SUMMARY

The present invention attempts to solve the problems explained above. An object of the present invention is to provide a composite magnetic material, a composite magnetic molded body, an electronic component and a method of making the same. Specifically, the composite magnetic material scarcely causes a deterioration of the electric characteristics of an electronic component because rust is hardly generated, and at the same time, can obtain an electronic component that is excellent in strength. The composite magnetic molded body can be obtained by heat curing the composite magnetic material. The electronic component can be obtained by using the composite magnetic molded body.

According to the earnest investigation by the inventors of the present invention in order to solve the above problems, the inventors discovered the following and completed measures relating to the present invention. Specifically, when a specific amount of a specific organic metallic soap (organometallic soap) is blended, during thermosetting (heat curing), the blended organic metallic soap is melted and spreads on the surface of the metal magnetic powder, for instance, a part of the surface of the metal magnetic powder that is not coated with a binder (a thermosetting resin) is coated. As a result, the part that is not coated significantly decreases (in size) and the rust prevention performance for withstanding a salt water spray test is enhanced.

The inventors of the present invention presume that a melting material of the organic metallic soap selectively closes the part that is not coated with the binder (the thermosetting resin), i.e., for instance, the melting material selectively closes a pinhole in the surface of the metal magnetic powder that is exposed.

In order to achieve the above object, a composite magnetic material according to one aspect of the present invention includes: a metal magnetic powder; a binder resin; and an organic metallic (organometallic) soap. A melting point of the organic metallic soap is equal to or lower than a thermosetting temperature of the binder resin. When the metal magnetic powder is abbreviated as MMP, the binder resin is abbreviated as BR, and the organic metallic soap is abbreviated as OMS, the following formula is satisfied: 0.01 wt %<(wt % of OMS)/(wt % of OMS+wt % of MMP+wt % of BR)×100<2.0 wt %. Note that the above composite magnetic material may be referred to as “a material of the present invention.”

A composite magnetic heat-cured body according to another aspect of the present invention is provided by curing a composite magnetic molded body. The composite magnetic molded body is provided by molding a composite magnetic material. The composite magnetic heat-cured body includes: a metal magnetic powder; a binder resin; and an organic metallic soap. The organic metallic soap and the binder completely or substantially completely cover an entire surface (e.g., encapsulate) of the metal magnetic powder. A melting point of the organic metallic soap is equal to or lower than a thermosetting temperature of the binder resin. When the metal magnetic powder is abbreviated as MMP, the binder resin is abbreviated as BR, and the organic metallic soap is abbreviated as OMS, the following formula is satisfied: 0.01 wt %<(wt % of OMS)/(wt % of OMS+wt % of MMP+wt % of BR)×100<2.0 wt %. Note that the above composite magnetic heat-cured body is referred to as “a heat-cured body of the present invention.”

An electronic component according to another aspect of the present invention includes the above composite magnetic heat-cured body. An (electronic or magnetic) element embedded into the composite magnetic heat-cured body. It is preferred that the (electronic or magnetic) element is a coil.

In a method for manufacturing an electronic component according to another aspect of the present invention includes: preparing a composite magnetic material by mixing a metal magnetic powder, a binder resin, and an organic metallic soap, wherein when the metal magnetic powder is abbreviated as MMP, the binder resin is abbreviated as BR, and the organic metallic soap is abbreviated as OMS, the following formula is satisfied: 0.01 wt %<(wt % of OMS)/(wt % of OMS+wt % of MMP+wt % of BR)×100<2.0 wt %; preparing a composite magnetic molded body by molding the composite magnetic material and by embedding an (electronic or magnetic) element in the composite magnetic material so that the (electronic or magnetic) element is embedded into the composite magnetic molded body; and curing the composite magnetic molded body at a temperature higher than a melting point of the organic metallic soap. After the organic metallic soap is melted by the curing, the organic metallic soap is solidified. The cured binder resin and the solidified organic metallic soap completely or substantially completely cover a surface of the metal magnetic powder.

In a method for manufacturing an electronic component according to another aspect of the present invention includes: preparing a composite magnetic material by mixing a metal magnetic powder, a binder resin, and an organic metallic soap, wherein when the metal magnetic powder is abbreviated as MMP, the binder resin is abbreviated as BR, and the organic metallic soap is abbreviated as OMS, the following formula is satisfied: 0.01 wt %<(wt % of OMS)/(wt % of OMS+wt % of MMP+wt % of BR)×100<2.0 wt %; preparing a composite magnetic molded body by molding the composite magnetic material in a mold and by embedding an (electronic or magnetic) element in the composite magnetic material in the mold so that the (electronic or magnetic) element is embedded into the composite magnetic molded body; and curing the composite magnetic molded body at a temperature higher than a melting point of the organic metallic soap. After the organic metallic soap is melted by the curing, the organic metallic soap is solidified. The cured binder resin and the solidified organic metallic soap completely or substantially completely cover a surface of the metal magnetic powder.

In a method for manufacturing an electronic component according to another aspect of the present invention includes: preparing a composite magnetic material by mixing a metal magnetic powder, a binder resin, an organic metallic soap, and a plasticizer, wherein when the metal magnetic powder is abbreviated as MMP, the binder resin is abbreviated as BR, and the organic metallic soap is abbreviated as OMS, the, a following formula is satisfied: 0.01 wt %<(wt % of OMS)/(wt % of OMS+wt % of MMP+wt % of BR)×100<2.0 wt %; preparing a composite magnetic molded body by molding the composite magnetic material in a mold and by embedding an (electronic or magnetic) element in the composite magnetic material in the mold so that the (electronic or magnetic) element is embedded into the composite magnetic molded body; and curing the composite magnetic molded body at a temperature higher than a melting point of the organic metallic soap. After the organic metallic soap is melted by the curing, the organic metallic soap is solidified. The cured binder resin and the solidified organic metallic soap completely or substantially completely cover a surface of the metal magnetic powder.

In a method for manufacturing an electronic component according to another aspect of the present invention includes: preparing a composite magnetic material by mixing a metal magnetic powder, a binder resin, an organic metallic soap, and a solvent, wherein when the metal magnetic powder is abbreviated as MMP, the binder resin is abbreviated as BR, and the organic metallic soap is abbreviated as OMS, the following formula is satisfied: 0.01 wt %<(wt % of OMS)/(wt % of OMS+wt % of MMP+wt % of BR)×100<2.0 wt %; preparing a composite magnetic molded body by molding the composite magnetic material in a mold and by embedding an (electronic or magnetic) element in the composite magnetic material in the mold so that the (electronic or magnetic) element is embedded into the composite magnetic molded body; and curing the composite magnetic molded body at a temperature higher than a melting point of the organic metallic soap. After the organic metallic soap is melted by the curing, the organic metallic soap is solidified. The cured binder resin and the solidified organic metallic soap completely or substantially completely cover a surface of the metal magnetic powder.

According to the present invention, a composite magnetic material, a composite magnetic molded body, an electronic component and a method of making the same can be provided. Specifically, the composite magnetic material scarcely causes a deterioration of electric characteristics because rust is hardly generated, and at the same time, can obtain an electronic component that is excellent in strength. The composite magnetic molded body can be obtained by heat curing the composite magnetic material. The electronic component can be obtained by using the composite magnetic molded body.

### BRIEF DESCRIPTION OF THE DRAWINGS

FIG. 1 is a diagram showing a manufacturing method of an electronic component (including a composite magnetic molded body and a composite magnetic cured body) according to embodiments of the present invention for their strength measurements.

### DESCRIPTION OF EXEMPLARY EMBODIMENTS

### Material According to the Present Invention

A material according to the present invention will be explained below.

As the material according to the present invention, a metal magnetic powder, a thermosetting resin, and an organic metallic soap are at least included.

The metal magnetic powder according to the present invention will be explained below.

The metal magnetic powder is not particularly limited so long as the magnetic powder includes iron as a main component. For instance, with the iron being the main component, chromium (Cr), silicon (Si), carbon (C), aluminum (Al) or manganese (Mn) can be added as an accessory component. Further, an amorphous metal powder can also be used.

Specifically, it is preferred that a content percentage of the iron in the metal magnetic powder is equal to or more than 90 wt %, and it is more preferred that the same is equal to or more than 92 wt %. Further, it is preferred that the same is equal to or less than 98 wt %, and it is more preferred that the same is equal to or less than 97 wt %.

It is preferred that the metal magnetic powder includes at least one of the accessory components explained above, and the balance is the iron and inevitable impurities.

The metal magnetic powder is preferred to include 2-10 wt % of Cr, and is more preferred to include 3-8 wt % of Cr.

Cr combines with oxygen in atmosphere, and easily generates a chemically stabled oxide (for instance, Cr₂O₃). Therefore, the composite magnetic material including Cr is particularly excellent in corrosion resistant. Further, because a chromium oxide has high specific resistance, particles that is composed of the composite magnetic material (the metal magnetic powder) can be more surely insulated by forming a chromium oxide layer near surfaces of the particles.

Thus, when a content percentage of Cr is within the range explained above, the composite magnetic material, which is capable of manufacturing an electronic component that has excellent corrosion resistance and smaller eddy current loss, can be obtained.

The metal magnetic powder is preferred to include 2-10 wt % of Si, and is more preferred to include 3-8 wt % of Si. Si can enhance a magnetic permeability of an electronic component that is obtained by using the metal magnetic powder. Further, because specific resistance becomes high when the metal magnetic powder includes Si, an induced current that is generated in the electronic component such as a powder magnetic core decreases so as to decrease an eddy current loss.

Thus, when a content percentage of Si is within the range explained above, the composite magnetic material, which is capable of being used in manufacturing the electronic component that enhances the magnetic permeability and has smaller eddy current loss, can be obtained.

The metal magnetic powder is preferred to include 0.5-2.0 wt % of C (Carbon), and is more preferred to include 0.7-1.5 wt % of C. It is further preferred to include about 0.5 wt % of C. When a content percentage of C (Carbon) is within the range explained above, it is a core loss can be suppressed.

The metal magnetic powder is preferred to include 2-10 wt % of Al, and is more preferred to include 3-8 wt % of Al. Al combines with oxygen in atmosphere, and easily generates a chemically stable oxide (for instance, Al₂O₃). Therefore, the composite magnetic material including Al is particularly excellent in corrosion resistant. Further, because an aluminum oxide is specifically solid and has a higher stability, particles that are composed of the composite magnetic material (the metal magnetic powder) can be more surely insulated by forming an aluminum oxide layer near surfaces of the particles.

Thus, when a content percentage of Al is within the range explained above, the composite magnetic material, which is capable of manufacturing the electronic component that has excellent corrosion resistance and smaller eddy current loss, can be obtained.

Other than the main component and the accessory components explained above, as a component that is smaller than the accessory components regarding the content percentage, the metal magnetic powder can also include at least one of, for instance, boron (B), titanium (Ti), vanadium (V), manganese (Mn), cobalt (Co), nickel (Ni), copper (Cu), gallium (Ga), germanium (Ge), zirconium (Zr), niobium (Nb), molybdenum (Mo), ruthenium (Ru), rhodium (Rh) and tantalum (Ta). In this case, it is preferred that a total content percentage of this (these) component(s) is equal to or less than 1 wt %.

Further, the metal magnetic powder can also include a component of, for instance, phosphorus (P) and/or sulfur (S) that is inevitably mixed in a manufacturing process. In this case, it is preferred that a total content percentage of this (these) component(s) is equal to or less than 1 wt %.

A mean particle diameter of the metal magnetic powder is preferred to be 5-30 μm, is more preferred to be 7-25 μm, and is further preferred to be 8-20 μm.

It is preferred that the metal magnetic powder is manufactured by a water atomization method. With respect to the water atomization method, a molten metal (a dissolving metal) is collided with water that is jetted at a high speed (atomized water) and is atomized and cooled, and as a result, a metal powder is manufactured. A surface of the metal magnetic powder that is manufactured by the water atomization method is oxidized in the manufacturing process, and an oxide layer that includes an iron oxide is naturally formed on the surface.

Further, a shape of the metal magnetic powder that is manufactured by the water atomization method is substantially spherical. As a result, a composite magnetic material that can be eventually obtained has high flowability (fluidity/movability), and when a composite magnetic heat-cured body and an electronic component are manufactured by using this metal magnetic powder, a filling rate thereof can be improved. Thus, a product with a high density and a high magnetic flux density can be obtained.

In regards to the material (the composite magnetic material) according to the present invention, it is preferred that a content percentage of the metal magnetic powder is 90-99 wt %, and it is more preferred that the same is 92-98 wt %.

A binder resin according to the present invention will be explained below. The binder resin is not particularly limited so long as it plays roles as a binder. As an organic thermosetting binder or an organic thermoplastics binder, for instance, a silicon based (system) resin, an epoxy based (system) resin, a phenol based (system) resin, a polyamide based (system) resin, a polyimide based (system) resin, and a polyphenylene sulfide based (system) resin can be used. As an inorganic binder, for instance, phosphate such as magnesium phosphate, calcium phosphate, tribasic zinc phosphate, manganese phosphate, and cadmium phosphate, and silicate (water glass) such as sodium silicate can also be used. However, a silicon based (system) resin or an epoxy based (system) thermosetting resin is specifically preferred. These resin materials are easily cured by heating, and at the same time, are excellent in heat resistance.

With respect to the content of a binder resin according to the material of the present invention, it is preferred that its calculated value (weight) is 1.0-10.0 wt %, and it is more preferred that its calculated value (weight) is 2.0-8.0 wt %, and it is further preferred that its calculated value (weight) is substantially 4.0 wt %. The calculated value (weight) is obtained by the following formula: (the content (weight) of a binder resin)/(the content (weight) of a binder resin+the content (weight) of a metal magnetic powder)×100.

When the content of the binder resin according to the material of the present invention is within the range explained above, the composite magnetic material scarcely causes a deterioration of electric characteristics of an electronic component because rust is hardly generated, and at the same time, can obtain an electronic component that is excellent in strength.

An organic metallic soap according to the present invention will be explained below. The organic metallic soap is not particularly limited so long as a melting point thereof is equal to or lower than a thermosetting temperature (curing temperature) of the binder resin explained above, and at the same time, Na (sodium) or K (potassium) is not included.

Here, a heat treatment (thermosetting or heat curing) temperature of a binder resin is determined to be within a certain range based on the types/kinds of binder resins. However, a specific temperature is selected from the range. For instance, when the heat curing is performed by applying the heat treatment at 150° C. by using a binder resin that is preferably heat-cured in a range of 130-230° C., the heat treatment temperature (thermosetting or heat curing) is 150° C. In this case, an organic metallic soap, in which a melting point is equal to or lower than 150° C., is used.

As an organic metallic soap, for instance, a long chain fatty acid metallic soap can be used. Specifically, for instance, a stearic acid metallic soap, a propionic acid metallic soap, a naphthenic acid metallic soap, a behenic acid based (system), a montanic acid based (system), a lauric acid based (system), an octylic acid metallic soap, and a ricinoleic acid metallic soap can be used. More specifically, for instance, magnesium stearate, calcium stearate, calcium laurate, aluminum laurate, calcium 12-hydroxystearate, zinc 12-hydroxystearate, magnesium 12-hydroxystearate, aluminum 12-hydroxystearate, barium 12-hydroxystearate, lithium 12-hydroxystearate, zinc stearate, calcium behenate, calcium octisalate, barium stearate, aluminum stearate, and zinc laurate can be used.

As the content of an organic metallic soap according to the material of the present invention, it is preferred that its calculated value (weight) is more than 0.01 wt % and less than 2.0 wt %, it is more preferred that its calculated value (weight) is 0.02-1.8 wt %, and it is further preferred that its calculated value (weight) is 0.20-1.0 wt %. The calculated value (weight) is obtained by the following formula: (the content (weight) of an organic metallic soap)/(the content (weight) of an organic metallic soap+the content (weight) of a metal magnetic powder+the content (weight) of a binder resin)×100.

When the content of the organic metallic soap of the material according to the present invention is within the range explained above, the composite magnetic material scarcely causes a deterioration of electric characteristics of an electronic component because rust is hardly generated, and at the same time, can be used to obtain an electronic component that is excellent in strength.

As the material according to the present invention, the metal magnetic powder, the binder resin, and the organic metallic soap explained above are included, and a solvent can also be included. It is preferred that the solvent is mixed with the other component after the solvent is added to the binder resin.

The solvent is not particularly limited so long as the solvent is an organic solvent that can dissolve the binder resin, and for instance, toluene, chloroform, and ethyl acetate can be used.

A content percentage of the solvent according to the material of the present invention is not particularly limited, however, it is preferred that it is 1.0-10.0 wt %, and it is more preferred that it is 2.0-8.0 wt %.

As the material according to the present invention, the metal magnetic powder, the binder resin, and the organic metallic soap explained above are included. Further, after a composite magnetic molded body is obtained by molding, the composite magnetic molded body is heat-cured (thermoset) at a thermosetting (heat curing) temperature explained above. As a result, a composite magnetic heat-cured body, which is made of the metal magnetic powder completely or substantially completely covered by the cured binder resin and the solidified organic metallic soap after being dissolved, can be obtained.

The composite magnetic molded body and the composite magnetic heat-cured body will be explained below.

A classification can also be applied to the material according to the present invention. As a method for classifying, for instance, dry classifications such as a sieving (screening) classification, an inertia classification, a centrifugal classification, and wet classifications such as a sedimentary classification can be used.

The material according to the present invention can also be granulated. As a method for granulating, conventionally known methods such as kneading granulation (kneading and granulating) and pelletizing can be applicable.

### Method for Manufacturing the Material According to the Present Invention

A method for manufacturing the material according to the present invention will be explained below.

The material according to the present invention can be obtained by mixing the metal magnetic powder, the binder resin, and the organic metallic soap in the amount explained above. In addition, a solvent can also be included.

Further, in order to obtain the material, after mixing the binder resin, the organic metallic soap, and the solvent, the metal magnetic powder can be added to this mixture and mixed. Further, after mixing the metal magnetic powder and the organic metallic soap, the binder resin and the solvent as necessary can also be added to this mixture and mixed. Further, after mixing the metal magnetic powder, the binder resin, and the solvent as necessary, the organic metallic soap can also be added to this mixture and mixed.

At this time, the mixture can be performed by a kneading granulation (kneading and granulating) method. Further, a classification can also be performed after mixing. As a method for classifying, for instance, dry classifications such as a sieving (screening) classification, an inertia classification, a centrifugal classification, and wet classifications such as a sedimentary classification can be used.

When the solvent is included in the material according to the present invention, volatilization of the solvent may occur by mixing. Therefore, there is also a case when the solvent is hardly included in the material according to the present invention after mixing.

### Heat-Cured (Thermoset) Body According to the Present Invention

A heat-cured body according to the present invention will be explained below.

The heat-cured body according to the present invention corresponds to a composite magnetic heat-cured body that is obtained by heat curing a composite magnetic molded body that is obtained by molding the material according to the present invention explained above.

The composite magnetic molded body can be obtained with the material according to the present invention by molding by conventionally known methods. This molding method is preferable to be the same method as a molding process regarding of a method for manufacturing an electronic component according to the present invention explained below.

Further, the shape and the size of the composite magnetic molded body are not particularly limited.

The composite magnetic molded body is heat-cured by applying heat at a certain thermosetting temperature, and as a result, the heat-cured body according to the present invention can be obtained. The heat curing can be performed by the conventionally known methods. This heat curing method is preferable to be the same method as a heat curing process of manufacturing an electronic component according to the present invention explained below.

The heat-cured body according to the present invention corresponds to the composite magnetic heat-cured body that is obtained by heat curing the composite magnetic molded body that is obtained by molding the material according to the present invention. Specifically, by heat curing the composite magnetic molded body at the thermosetting temperature, the composite magnetic heat-cured body, in which a surface of the metal magnetic powder is coved by the cured binder resin and the solidified organic metallic soap after being dissolved, can be obtained.

Further, the compositions of the composite magnetic molded body explained above and the heat-cured body according to the present invention are, in principle, the same as the compositions of the material (the composite magnetic material) according to the present invention.

### Method for Manufacturing a Heat-Cured Body According to the Present Invention

A method for manufacturing a heat-cured body according to the present invention will be explained below.

The method for manufacturing the heat-cured body according to the present invention includes a raw material preparation process and a molding process in the same manner as a method for manufacturing an electronic component according to the present invention explained below. Further, it is preferred that a process, in which the heat curing is performed without including any member (an electronic or magnetic element such as a coil) in a heat curing process performed in the method for manufacturing the electronic component according to the present invention, is provided.

### Electronic Component According to the Present Invention

An electronic component according to the present invention will be explained below.

As the electronic component according to the present invention, the heat-cured body according to the present invention explained above, in which a member (an electronic or magnetic element) is embedded, is provided.

Here, as the member, various magnetic elements (electromagnetic components) that have magnetic cores can be used. Specifically, for instance, a coil (including a choke coil), an inductor, a noise filter, a reactor, a motor, a power generator, a transformer, and an antenna can be used.

### Method for Manufacturing an Electronic Component According to the Present Invention

A method for manufacturing an electronic component according to the present invention will be explained below.

The method for manufacturing the electronic component according to the present invention includes a raw material preparation process, a molding process, and a heat curing process. Further, the raw material preparation process can also be in the same way as the method for manufacturing the material according to the present invention explained above.

Preferred aspects (aspects 1-4) (embodiments) in regards to the method for manufacturing the heat-cured body according to the present invention will be explained below.

### Aspect 1

First of all, an aspect 1 that is one of the preferred aspects in regards to the method for manufacturing the heat-cured body according to the present invention will be explained below.

A raw material preparation process according to the aspect 1 is performed in the same manner as the method for manufacturing the material according to the present invention explained above. This process can make a composite magnetic material (the material according to the present invention) in which an amount of a solvent is small or the solvent hardly exist.

In other words, in the raw material preparation process according to the aspect 1, a metal magnetic powder, a binder resin, an organic metallic soap, and a solvent are mixed. Because a mixing ratio (mixing degree) is adjusted at this time, the solvent can be volatilized, and according to circumstances, the solvent can also be evaporated by heating at a temperature lower than a melting point of the organic metallic soap. It is preferred that a content percentage of the solvent before the mixing is 5-15 wt %. Also, it is preferred that the content percentage of the solvent is substantially 0 wt % by drying the solvent after mixing and granulating. An example method of these mixings, for instance, a kneading granulation (kneading and granulating) can be used. The kneading granulation (kneading and granulating) may be performed after mixing in the other methods, and the classification may also be performed.

Further, it is possible that the state of the composite magnetic material that is obtained in the raw material preparation process can be changed from a dry powder-like state to a clay-like state based on requests or requirements of the subsequent molding process.

In a molding process according to the aspect 1, the composite magnetic material that is obtained in the raw material preparation process explained above is used and molded, and as a result, a composite magnetic molded body [1], in which a member (electronic or magnetic element, such as a coil) is embedded, can be obtained.

The method for obtaining the composite magnetic molded body [1], in which the member (electronic or magnetic element) such as the coil is embedded inside of the composite magnetic material, is not particularly limited. For instance, the conventionally known method can be applied.

For instance, after the member such as the coil and the composite magnetic material are inserted into a predetermined mold, the composite magnetic molded body [1] can be obtained by molding and pressing (by compression molding) in which the composite magnetic material is pressed at a predetermined high pressure, for instance, 3-5 ton/cm².

Further, the composite magnetic molded body [1] can also be obtained by molding in which the composite magnetic material explained above is pushed into the mold by applying a predetermined pressure, which is by far smaller as compared with the compression molding explained above, and for instance, its pressure is about one thousandth (3-5/1000 ton/cm²).

In the heat curing process according to the aspect 1, the composite magnetic molded body [1] that is obtained by the molding process explained above is heat-cured (thermoset) at a thermosetting temperature higher than the melting point of the organic metallic soap.

A period of time for the heat curing (thermosetting) is also not particularly limited, and for instance, 0.1-5 hours can be adopted. It is preferred that the period of time is 0.2-1 hour.

A method for the heat curing is also not particularly limited, and for instance, the heat curing is performed by using a conventionally known thermostatic chamber (oven).

### Aspect 2

An aspect 2 will be explained below.

In a raw material preparation process according to the aspect 2, a binder resin that has fluidity at an ordinary temperature is used. Further, a solvent does not need to be included.

In this case, when a metal magnetic powder, the binder resin, and an organic metallic soap are mixed, a clay-like composite magnetic material (a composite magnetic material in a clay-like state) can be obtained.

As an example of the mixing, for instance, the kneading granulation (kneading and granulating) can be used. The kneading granulation (kneading and granulating) can also be performed after mixing by the other methods.

In a molding process according to the aspect 2, the composite magnetic material that is obtained in the raw material preparation process explained above is pushed into a mold and is molded, and as a result, a composite magnetic molded body [2], in which a member (electronic or magnetic element, such as a coil) is embedded, can be obtained.

The method for obtaining the composite magnetic molded body [2], in which the member (electronic or magnetic element) such as the coil is embedded inside of the composite magnetic material, is not particularly limited. For instance, the conventionally known method can be applied.

For instance, the member such as the coil and the composite magnetic material are placed in a predetermined mold, and the composite magnetic molded body [2] can be formed by pushing the composite magnetic material into the mold by applying a predetermined pressure.

A heat curing (thermosetting) process according to the aspect 2 can be the same as the heat curing process according to the aspect 1.

Because the clay-like composite magnetic material is used for the electronic component according to the present invention that is obtained by the method of the aspect 2, the molding is performed by applying a low pressure and there is no sign of granulating. Therefore, it is superior because damages to the member that corresponds to such as the coil embedded inside the composite magnetic material are small.

### Aspect 3

An aspect 3 will be explained below.

In a raw material preparation process according to the aspect 3, a composite magnetic material (the material according to the present invention) that includes a plasticizer in addition to a metal magnetic powder, a binder resin, and an organic metallic soap can be obtained.

As the plasticizer, an organic solvent, in which a boiling point is more than 150° C., such as a diethyl phthalate can be used.

Further, a dosage (addition amount) of the plasticizer can be 1-4 wt % with respect to the material according to the present invention.

In this case, when the metal magnetic powder, the binder resin, the organic metallic soap, and the plasticizer are mixed, a clay-like composite magnetic material (a composite magnetic material in a clay-like state) can be obtained.

A molding process according to the aspect 3 can be the same as the molding process according to the aspect 2.

A heat curing process according to the aspect 3 can be the same as the heat curing process according to the aspect 1.

Because the clay-like composite magnetic material is used for an electronic component according to the present invention that is obtained by the method according to the aspect 3, the molding is performed by applying a low pressure and there is no sign of granulating. Therefore, it is superior because damages to the member that corresponds to such as the coil embedded inside the composite magnetic material are small.

### Aspect 4

An aspect 4 will be explained below.

A raw material preparation process according to the aspect 4 is the same as the method for manufacturing the material according to the present invention explained above and is the process in which the composite magnetic material (the material according to the present invention) that includes the solvent is obtained.

In other words, in the raw material preparation process according to the aspect 4, a metal magnetic powder, a binder resin, an organic metallic soap, and a solvent are stirred (agitated) and mixed. For instance, a content percentage of the solvent before mixing can be 5-10 wt %, and in this case, the content percentage of the solvent after mixing hardly changes. In other words, the stirring and mixing, in which the content percentage of the solvent is not substantially changed, is performed.

In this case, a slurry composite magnetic material (a composite magnetic material in a slurry state) can be obtained.

In a molding process according to the aspect 4, the composite magnetic material that is obtained in the raw material preparation process explained above is poured into a mold and is molded, and as a result, the composite magnetic molded body [2] in which a member is embedded can be obtained.

The method for obtaining the composite magnetic molded body [2], in which the member (electronic or magnetic element) such as the coil is embedded inside of the composite magnetic material, is not particularly limited. For instance, the conventionally known method can be applied.

For instance, after the member such as the coil is placed in and the composite magnetic material is poured into a predetermined mold, the composite magnetic molded body [2] is molded.

In a heat curing process according to the aspect 4, the heat treatment is applied to an object of the molded body that is obtained by the molding process explained above. That is, the molded body that includes both the member (such as a coil) and the composite magnetic material still located in the mold is heat cured (is applied the heat treatment). In regards to the other steps, the heat curing process according to the aspect 4 can be the same as the heat curing process according to the aspect 1.

Because the slurry composite magnetic material (the composite magnetic material in a slurry state) is used for an electronic component according to the present invention that is obtained by the method according to the aspect 4, the molding is performed by casting (cast molding, pouring molding, or filling molding) without applying any pressure and there is no sign of granulating. Therefore, it is superior because damages to the member that corresponds to such as the coil embedded inside the composite magnetic material are small.

The methods for manufacturing the electronic component according to the present invention are represented by the aspects 1-4 explained above. The electric component is the composite magnetic heat-cured body in which the member (such as a coil) is embedded. Specifically, the composite magnetic heat-cured body is made of the metal magnetic powder completely or substantially completely covered by the cured binder resin and the solidified organic metallic soap after being dissolved.

### EMBODIMENTS

### Comparative Example 1

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared.

Next, after a resin solution is obtained by adding the binder resin to a solvent (toluene) and by sufficiently stirring and mixing the binder resin added solvent, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Embodiments 1-1-1-8; Comparative Examples 1-1-1-2

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, magnesium stearate (having a melting point of 140° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is respectively set to calculated values (weights) of 0.01 wt % (Comparative Example 1-1), 0.02 wt % (Embodiment 1-1), 0.05 wt % (Embodiment 1-2), 0.10 wt % (Embodiment 1-3), 0.20 wt % (Embodiment 1-4), 0.50 wt % (Embodiment 1-5), 1.00 wt % (Embodiment 1-6), 1.50 wt % (Embodiment 1-7), 1.80 wt % (Embodiment 1-8), and 2.00 wt % (Comparative Example 1-2). Each of the calculated values (weights) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, each of the disk-shaped molded bodies is thermoset (heat-cured) in a thermostatic chamber at 150° C. for 30 minutes, and makes it a sample.

### Embodiment 2

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, a magnesium stearate (having a melting point of 140° C.) is prepared as an organic metallic soap.

Next, the organic metallic soap is added to the metal magnetic powder, and the organic metallic soap and the metal magnetic powder are mixed by a V-type mixing machine for 30 minutes. Further, an amount of the organic metallic soap that is added to the metal magnetic powder is set to a calculated value (weight) of 0.50 wt %. The calculated value (weight) is obtained by the following formula: (weight of the organic metallic soap)/(weight of the organic metallic soap+weight of the metal magnetic powder+weight of the binder resin)×100.

Next, after a mixture is obtained by adding the organic metallic soap to the metal magnetic powder, the binder resin and a small amount of toluene are added to the mixture. The mixture added with the binder resin and the small amount of toluene is sufficiently stirred and mixed, kneaded and granulated, and sized (size-selected) through a sieve (screen), and as a result, a granulated powder is obtained. Further, an amount of the binder resin is set to a calculated value (weight) of 4 wt %. The calculated value (weight) of the binder resin is obtained by the following formula: (weight of the binder resin)/(weight of the binder resin+weight of the metal magnetic powder)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Embodiment 3

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, a magnesium stearate (having a melting point of 140° C.) is prepared as an organic metallic soap.

Next, after a mixture is obtained by adding the binder resin and a small amount of toluene to the metal magnetic powder, the mixture added with the binder resin and the small amount of toluene is sufficiently stirred and mixed, kneaded and granulated, and sized (size-selected) through a sieve (screen), and as a result, a granulated powder is obtained. Further, an amount of the binder resin is set to a calculated value (weight) of 4 wt %. The calculated value (weight) is obtained by the following formula: (weight of the binder resin)/(weight of the binder resin+weight of the metal magnetic powder)×100.

Next, the organic metallic soap is added to the granulated powder that is obtained explained above, and the organic metallic soap and the granulated powder are mixed by a V-type mixing machine for 30 minutes. Further, an amount of the organic metallic soap that is added to the granulated powder is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Comparative Example 4-1, Embodiment 4-1

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, a calcium stearate (having a melting point of 160° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample (Comparative Example 4-1). In addition, the disk-shaped molded body, which is different from the previous disk-shaped molded body (Comparative Example 4-1), is thermoset (heat-cured) in the thermostatic chamber at 180° C. for 30 minutes, and makes it a sample (Embodiment 4-1).

### Comparative Example 5-1, Embodiment 5-1

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, a calcium laurate (having a melting point of 155° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample (Comparative Example 5-1). In addition, the disk-shaped molded body, which is different from the previous disk-shaped molded body (Comparative Example 5-1), is thermoset (heat-cured) in the thermostatic chamber at 180° C. for 30 minutes, and makes it a sample (Embodiment 5-1).

### Comparative Example 6-1, Embodiment 6-1

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, aluminum stearate (having a melting point of 165° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample (Comparative Example 6-1). In addition, the disk-shaped molded body, which is different from the previous disk-shaped molded body (Comparative Example 5-1), is thermoset (heat-cured) in the thermostatic chamber at 180° C. for 30 minutes, and makes it a sample (Embodiment 6-1).

### Embodiment 7

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, calcium 12-hydroxystearate (having a melting point of 145° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Embodiment 8

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, zinc stearate (having a melting point of 120° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Embodiment 9

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, calcium behenate (behenic acid Ca, having a melting point of 145° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Embodiment 10

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, calcium octisalate (montanic acid Ca or calcium montanate; having a melting point of 135° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Comparative Example 2

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, barium stearate (having a melting point of 220° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 2 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 150° C. for 30 minutes, and makes it a sample.

### Comparative Example 3

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting silicone resin is prepared.

Next, after a resin solution is obtained by adding the binder resin to toluene and by sufficiently stirring and mixing the binder resin added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100.

Next, the granulated powder is molded by applying a pressure of 3 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 200° C. for 30 minutes, and makes it a sample.

### Embodiments 11-1-11-8, Comparative Examples 1-1-1-2

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting silicone resin is prepared. Further, aluminum stearate (having a melting point of 165° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is respectively set to calculated values (weights) of 0.01 wt % (Comparative Example 11-1), 0.02 wt % (Embodiment 11-1), 0.05 wt % (Embodiment 11-2), 0.10 wt % (Embodiment 11-3), 0.20 wt % (Embodiment 11-4), 0.50 wt % (Embodiment 11-5), 1.00 wt % (Embodiment 11-6), 1.50 wt % (Embodiment 11-7), 1.80 wt % (Embodiment 11-8), and 2.00 wt % (Comparative Example 11-2). Each of the calculated values (weights) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 3 ton/cm² and by using a mold so that a disk-shaped molded body having an outer diameter of 10 mm and a thickness of 1 mm is manufactured.

Further, each of the disk-shaped molded bodies is thermoset (heat-cured) in a thermostatic chamber at 200° C. for 30 minutes, and makes it a sample.

### Comparative Example 4

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting silicone resin is prepared. Further, barium stearate (having a melting point of 220° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution and the toluene is evaporated by mixing the metal magnetic powder and the resin solution so that the mixture is kneaded and granulated, and sized (size-selected) through a sieve (screen), and as a result, a granulated powder is obtained. Further, an amount of the binder resin that is added to the toluene is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap that is added to the toluene is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100.

Next, the granulated powder is molded by applying a pressure of 3 ton/cm² and by using a mold so that a disk-shaped molded body having an outer diameter of 10 mm and a thickness of 1 mm is manufactured.

Further, the disk-shaped molded body is thermoset (heat-cured) in a thermostatic chamber at 200° C. for 30 minutes, and makes it a sample.

### Embodiment 12

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin that has fluidity at an ordinary temperature is prepared. Further, calcium stearate (having a melting point of 160° C.) is prepared as an organic metallic soap.

Next, the organic metallic soap is added to the metal magnetic powder, and the organic metallic soap and the metal magnetic powder are mixed by a V-type mixing machine for 30 minutes. Further, an amount of the organic metallic soap that is added to the metal magnetic powder is set to a calculated value (weight) of 0.50 wt %. The calculated value (weight) is obtained by the following formula: (weight of the organic metallic soap)/(weight of the organic metallic soap+weight of the metal magnetic powder)×100.

Next, the organic metallic soap is added to the metal magnetic powder and the binder resin is added to the mixture of the organic metallic soap and the metal magnetic powder. Further, the mixture added with the binder resin is sufficiently kneaded, and as a result, a clay-like composite magnetic material (a composite magnetic material in a clay-like state) is obtained. Further, an amount of the binder resin is set to a calculated value (weight) of 7 wt %. The calculated value (weight) is obtained by the following formula: (weight of the binder resin)/(weight of the binder resin+weight of the metal magnetic powder+weight of the organic metallic soap)×100.

Next, the clay-like composite magnetic material is casted (pushed) in a mold so that a disk-shaped molded body having an outer diameter of 10 mm and a thickness of 1 mm is manufactured.

Further, the disk-shaped molded body is thermoset (heat-cured) in a thermostatic chamber at 180° C. for 30 minutes, and makes it a sample.

### Embodiment 13

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, aluminum stearate (having a melting point of 165° C.) is prepared as an organic metallic soap.

Next, after a resin solution is obtained by adding the binder resin and the organic metallic soap to diethyl phthalate (DEP) (a solvent) and by sufficiently stirring and mixing the binder resin and the organic metallic soap added DEP, the metal magnetic powder is added to the resin solution, and the mixture is sufficiently kneaded, and as a result, a clay-like composite magnetic material (a composite magnetic material in a clay-like state) is obtained. Further, an amount of the binder resin is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100. Further, an amount of the DEP is set to a calculated value (weight) of 2.0 wt %. The calculated value (weight) of the DEP is obtained by the following formula: (weight of the DEP)/(weight of the DEP+weight of the metal magnetic powder+weight of the binder resin)×100.

Next, the clay-like composite magnetic material is casted (pushed) in a mold so that a disk-shaped molded body having an outer diameter of 10 mm and a thickness of 1 mm is manufactured.

Further, the disk-shaped molded body is thermoset (heat-cured) in a thermostatic chamber at 180° C. for 30 minutes, and makes it a sample.

### Embodiment 14

A water atomized powder having a mean particle diameter (D₅₀) of 12 μm is prepared as a metal magnetic powder. The metal magnetic powder has a composition including 4 wt % of chromium, 4 wt % of silicon, 0.5 wt % of carbon, and the balance iron. Further, the mean particle diameter is measured by using MicrotracSRA150 (manufactured by HORIBA, Ltd.). Further, as a binder resin, a thermosetting epoxy resin is prepared. Further, aluminum stearate (having a melting point of 165° C.) is prepared as an organic metallic soap.

Next, after a resin solution is obtained by adding the binder resin and the organic metallic soap to toluene and by sufficiently stirring and mixing the binder resin and the organic metallic soap added toluene, the metal magnetic powder is added to the resin solution, and the mixture is sufficiently kneaded, and as a result, a slurry composite magnetic material (a composite magnetic material in a slurry state) is obtained. Further, an amount of the binder resin is set to a calculated value (weight) of 4 wt %. The calculated value (weight) is obtained by the following formula: (weight of the binder resin)/(weight of the binder resin+weight of the metal magnetic powder)×100. Further, an amount of the organic metallic soap is set to a calculated value (weight) of 0.50 wt %. The calculated value (weight) of the organic metallic soap is obtained by the following formula: (weight of the organic metallic soap)/(weight of the organic metallic soap+weight of the metal magnetic powder+weight of the binder resin)×100. Further, an amount of the toluene is set to a calculated value (weight) of 5.0 wt %. The calculated value (weight) of the toluene is obtained by the following formula: (weight of the toluene)/(weight of the toluene+weight of the metal magnetic powder+weight of the binder resin)×100.

Next, the slurry composite magnetic material (the composite magnetic material in a slurry state) is casted (by cast molding, pouring molding, or filling molding) in a mold, the toluene is dried by heating at 50° C., and is removed from the mold so that a disk-shaped molded body having an outer diameter of 10 mm and a thickness of 1 mm is manufactured.

Further, the disk-shaped molded body is thermoset (heat-cured) in a thermostatic chamber at 180° C. for 30 minutes, and makes it a sample.

### Salt Spray Test

A salt spray test (according to JIS (Japanese Industrial Standard)-Z2371; at 35° C., for 24 Hours) is conducted on the samples of the disk-shaped molded bodies that are manufactured in the each of the embodiments and each of the comparative examples explained above and rust generations are observed. Further, an area of rust is measured on each sample.

The results are shown in Table 1. Specifically, in Table 1, the mark “⊚” indicates when the rust generation in a sample area is less than 2%, the mark “◯” indicates when the rust generation in a sample area is 2% or more and less than 5%, the mark “X” indicates when the rust generation in a sample area is more than 5%. Further, both marks “⊚” and “◯” indicate to be judged as “having an effect” (excellent), and the mark “X” indicates to be judged as “bad” (inferior).

### Strength Measurement of Composite Material

After the composite magnetic materials in the granulated powder state (shown in the embodiments 1-11 and the comparative examples), and the composite magnetic materials in the clay-like state (shown in the embodiments 12 and 13), and the composite magnetic material in the slurry state (shown in the embodiment 14) that are obtained in the embodiments and the comparative examples explained above are molded with the coils according to the following method, the thermosetting treatment is performed under the same condition (for instance, the temperature and the time) as the condition when each of the embodiments and the comparative examples explained above is performed. As a result, the electronic components in product states are manufactured. Further, a strength measurement is performed on each of these samples of the electronic components in product states. The specific explanation will be provided below.

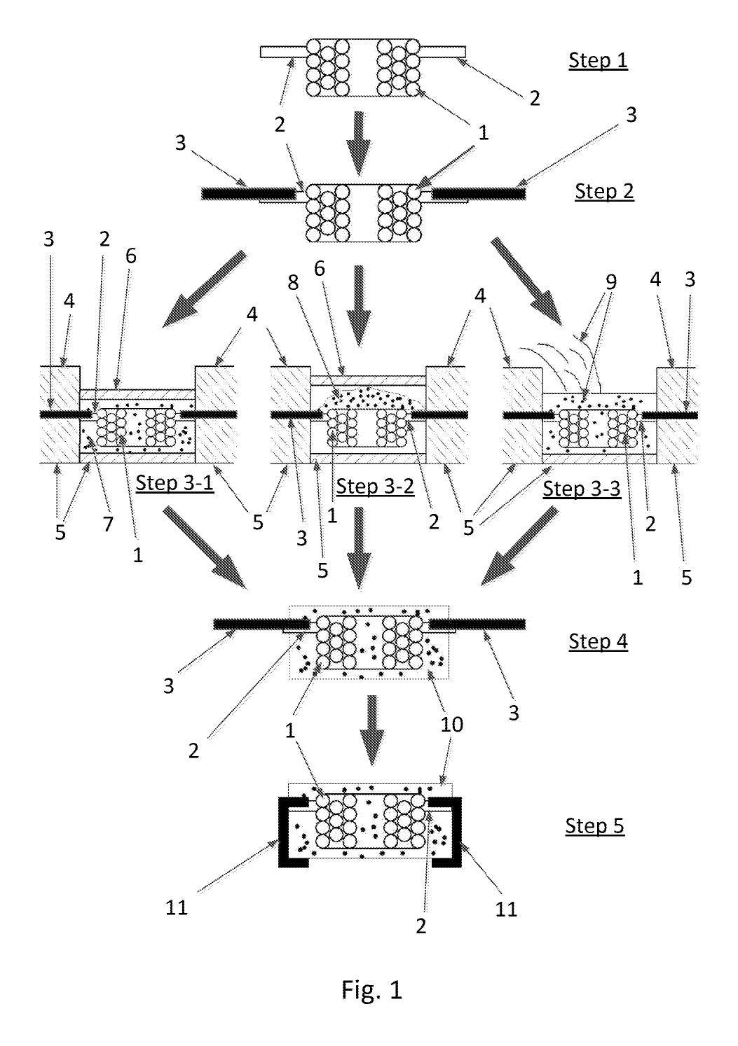

FIG. 1 is a diagram to show a manufacturing method (Step 1-Step 5) of an electronic component (including a composite magnetic molded body and a composite magnetic cured body) according to embodiments of the present invention for their strength measurements.

### Step 1

In Step 1 of FIG. 1, an air-core coil 1 that having an inner diameter of 3.6 mm, a height of 3.6 mm and 14.5 turns is manufactured by using a coated lead wire 2 having a diameter of 0.3 mm.

### Step 2

In Step 2 of FIG. 1, ends of this air-core coil (ends of the lead wire 2) are fixed to a copper frame (a hoop, a lead frame) 3 that is coated with tin (Sn) and corresponds to an external electrode of a component so as to form a semi-manufactured product. Further, in Step 3 (Steps 3-1, 3-2 and 3-3) of FIG. 1, the air-core coil 1, part of the lead wire 2, and the electrode portion of the hoop (part of the copper frame 3) of this semi-manufactured product is set inside of a mold (die) (upper mold 4 and lower mold 5). Thereafter, depending on types or states of the composite magnetic materials discussed in the above embodiments and comparative examples, there are three different steps are performed.

### Step 3-1

As shown in Step 3-1 of FIG. 1, in regards to the embodiments 1-11 and the comparative examples, part of the lead wire 2 and part of the copper frame 3 are sandwiched between the upper mold 4 and the lower mold 5. The air-core coil 1 are located inside of the mold 4 and 5 so as to be spaced apart from inner and bottom surfaces of the upper and lower molds 4 and 5. Thereafter, the granulated powder composite magnetic material 7 (the composite magnetic material in the granulated powder state) is inserted in the mold 4 and 5 from above so that the granulated powder composite magnetic material 7 surrounds the air-core coil 1, part of the leas wire 2, and part of the copper frame 3. Thereafter, the granulated powder composite magnetic material 7 and the air-core coil 1 are molded by compression molding with a pressure of 2 ton/cm² or 3 ton/cm² from above via a lid plate 6, or alternatively from above and bottom. In general, a punch (not shown) is used for applying the pressure.

### Step 3-2

As shown in Step 3-2 of FIG. 1, in regards to the embodiments 12 and 13, the air-core coil 1, part of the lead wire 2 and part of the copper frame 3 are set inside of the mold 4 and 5 in the same manner as Step 3-1. Thereafter, a required amount of the clay-like composite magnetic material 8 is casted (pushed) in the mold 4 and 5 from above. Alternatively, before the air-core coil 1, part of the lead wire 2 and part of the copper frame 3 are set inside of the mold 4 and 5, the clay-like composite magnetic material 8 is partially placed (pushed) in the lower mold 5. Thus, when the clay-like composite magnetic material 8 is casted (pushed) in the mold 4 and 5 from above, the clay-like composite magnetic material 8 sufficiently surround the air-core coil 1, the leas wire 2 and the copper frame 3 with the pre-placed (pushed) the clay-like composite magnetic material 8. The latter method is fine because the clay-like composite magnetic material 8 has low flowability (fluidity/movability) compared with the granulated powder composite magnetic material 7 and the slurry composite magnetic material 9 (explained below). Thereafter, the clay-like composite magnetic material 8 and the air-core coil 1 is press-molded by applying a fairly low pressure of 1 kg/cm² from above via the lid plate 6, or alternatively from above and bottom. In general, a punch or a press machine (not shown) is used for applying the pressure.

### Step 3-3

As shown in Step 3-3 of FIG. 1, in regards to the embodiment 14, the air-core coil 1, part of the lead wire 2 and part of the copper frame 3 are set inside of the mold 4 and 5 in the same manner as Step 3-1. Thereafter, the slurry composite magnetic material 9 is casted (poured or filled) in the mold 4 and 5 (cast molding, pouring molding, or filling molding). Thereafter, the toluene is dried.

### Step 4

Next, in regards to each of the embodiments 1-14 and the comparative examples, the thermosetting (heat-curing) treatment is performed under the same conditions (for instance, the temperature and the time) as the conditions when the embodiments and the comparative examples explained above are respectively performed. In Step 4, the composite magnetic heat-cured body 10 is obtained.

### Step 5

Thereafter, an unnecessary copper frame 3 is cut and removed so that part of the copper frame 3 that corresponds to an electrode is left. Further, an outer electrode 11 of the electronic component, which will be connected to an external electrode, is formed by bending the copper frame 3 that is extended from the molded heat-cured body 10.

### Strength Measurement

The strength of each of the samples is measured by confirming whether the molded body is cracked or chipped because the molded heat-cured body 10 sufficiently holds the copper frame 3 (as the outer electrode) during bending the copper frame 3.

Specifically, the strength of the molded heat-cured body 10 is determined based on an amount of cracks or chippings on the molded heat-cured body 10 during bending the copper frame 3.

The result is shown in Table 1. In Table 1, the mark “⊚” indicates when the bending of the copper frame 3 could be properly done. The mark “◯” indicates when the bending of the copper frame 3 could be done, however, a tiny crack in the molded heat-cured body 10 is generated. The mark “X” indicates when the bending of the copper frame 3 could not be done properly because of the great cracks or chippings of the molded heat-cured body 10 so that the mark “X” is judged that the strength is insufficient. Thus, both marks “⊚” and “◯” indicate to be judged as “having an effect” (excellent), and the mark “X” indicates to be judged as “bad” (inferior).

In Table 1, abbreviated terms are used as described below (from left column to right column):
Comparative Example: CE;
Embodiment: EMB;
Binder Resin: BR;
   Epoxy Resin: ER; and
   Silicone Resin: SR;
Organic metallic Soap: OMS;
   magnesium stearate: Mg—S;
   calcium stearate: Ca—S;
   calcium laurate: Ca-L;
   aluminum stearate: Al—S;
   calcium 12-hydroxystearate: Ca-12;
   zinc stearate: Zn—S;
   calcium behenate: Ca—B;
   calcium octisalate: Ca—O; and
   barium stearate: Ba—S;
Melting Point of Organic metallic Soap: MP;
Organic metallic Soap Content: OMS-C;
Material in which Organic metallic Soap is added: MAT;
   Binder Resin: BR;
   Metal magnetic Powder: MMP; and
   Granulated Powder (binder resin and metal magnetic powder): GP;
Heat Curing (Thermosetting) Temperature: HCT;
Results of Salt Water Spray Test: SWT;
Result of Strength Measurement: SM; and
Comprehensive Judgement: CJ.

TABLE 1

| | | | MP | OMS-C | | HCT | | | |
|---|---|---|---|---|---|---|---|---|---|
| | BR | OMS | (° C.) | (wt %) | MAT | (° C.) | SWT | SM | CJ |
| CE 1 | ER | None | N/A | 0 | N/A | 150 | X | ⊚ | X |
| CE | ER | Mg—S | 140 | 0.01 | BR | 150 | X | ⊚ | X |
| 1-1 | | | | | | | | | |
| EMB | ER | Mg—S | 140 | 0.02 | BR | 150 | ◯ | ⊚ | ◯ |
| 1-1 | | | | | | | | | |
| EMB | ER | Mg—S | 140 | 0.02 | BR | 150 | ◯ | ⊚ | ◯ |
| 1-2 | | | | | | | | | |
| EMB | ER | Mg—S | 140 | 0.10 | BR | 150 | ◯ | ⊚ | ◯ |
| 1-3 | | | | | | | | | |
| EMB | ER | Mg—S | 140 | 0.20 | BR | 150 | ⊚ | ⊚ | ⊚ |
| 1-4 | | | | | | | | | |
| EMB | ER | Mg—S | 140 | 0.50 | BR | 150 | ⊚ | ⊚ | ⊚ |
| 1-5 | | | | | | | | | |
| EMB | ER | Mg—S | 140 | 1.00 | BR | 150 | ⊚ | ⊚ | ⊚ |
| 1-6 | | | | | | | | | |
| EMB | ER | Mg—S | 140 | 1.50 | BR | 150 | ⊚ | ◯ | ◯ |
| 1-7 | | | | | | | | | |
| EMB | ER | Mg—S | 140 | 1.80 | BR | 150 | ⊚ | ◯ | ◯ |
| 1-8 | | | | | | | | | |
| CE | ER | Mg—S | 140 | 2.00 | BR | 150 | ⊚ | X | X |
| 1-2 | | | | | | | | | |
| EMB 2 | ER | Mg—S | 140 | 0.50 | MMP | 150 | ⊚ | ⊚ | ⊚ |
| EMB 3 | ER | Mg—S | 140 | 0.50 | GP | 150 | ⊚ | ⊚ | ⊚ |
| CE | ER | Ca—S | 160 | 0.50 | BR | 150 | X | ⊚ | X |
| 4-1 | | | | | | | | | |
| EMB | ER | Ca—S | 160 | 0.50 | BR | 180 | ⊚ | ⊚ | ⊚ |
| 4-1 | | | | | | | | | |
| CE | ER | Ca-L | 155 | 0.50 | BR | 150 | X | ⊚ | X |
| 5-1 | | | | | | | | | |
| EMB | ER | Ca-L | 155 | 0.50 | BR | 180 | ⊚ | ⊚ | ⊚ |
| 5-1 | | | | | | | | | |
| CE | ER | Al—S | 165 | 0.50 | BR | 150 | X | ⊚ | X |
| 6-1 | | | | | | | | | |
| EMB | ER | Al—S | 165 | 0.50 | BR | 180 | ⊚ | ⊚ | ⊚ |
| 6-1 | | | | | | | | | |
| EMB 7 | ER | Ca- | 145 | 0.50 | BR | 150 | ⊚ | ⊚ | ⊚ |
| | | 12 | | | | | | | |
| EMB 8 | ER | Zn—S | 120 | 0.50 | BR | 150 | ⊚ | ⊚ | ⊚ |
| EMB 9 | ER | Ca—B | 145 | 0.50 | BR | 150 | ⊚ | ⊚ | ⊚ |
| EMB | ER | Ca—O | 135 | 0.50 | BR | 150 | ⊚ | ⊚ | ⊚ |
| 10 | | | | | | | | | |
| CE 2 | ER | Ba—S | 220 | 0.50 | BR | 180 | X | ◯ | X |
| CE 3 | SR | None | N/A | 0 | N/A | 200 | X | ⊚ | X |
| CE | SR | Al—S | 165 | 0.01 | BR | 200 | X | ⊚ | X |
| 11-1 | | | | | | | | | |
| EMB | SR | Al—S | 165 | 0.02 | BR | 200 | ◯ | ⊚ | ◯ |
| 11-1 | | | | | | | | | |
| EMB | SR | Al—S | 165 | 0.05 | BR | 200 | ◯ | ⊚ | ◯ |
| 11-2 | | | | | | | | | |
| EMB | SR | Al—S | 165 | 0.10 | BR | 200 | ◯ | ⊚ | ◯ |
| 11-3 | | | | | | | | | |
| EMB | SR | Al—S | 165 | 0.20 | BR | 200 | ⊚ | ⊚ | ⊚ |
| 11-4 | | | | | | | | | |
| EMB | SR | Al—S | 165 | 0.50 | BR | 200 | ⊚ | ⊚ | ⊚ |
| 11-5 | | | | | | | | | |
| EMB | SR | Al—S | 165 | 1.00 | BR | 200 | ⊚ | ⊚ | ⊚ |
| 11-6 | | | | | | | | | |
| EMB | SR | Al—S | 165 | 1.50 | BR | 200 | ⊚ | ◯ | ◯ |
| 11-7 | | | | | | | | | |
| EMB | SR | Al—S | 165 | 1.80 | BR | 200 | ⊚ | ◯ | ◯ |
| 11-8 | | | | | | | | | |
| CE | SR | Al—S | 165 | 2.00 | BR | 200 | ⊚ | X | X |
| 11-2 | | | | | | | | | |
| CE 4 | SR | Ba—S | 220 | 0.50 | BR | 200 | X | ⊚ | X |
| EMB | ER | Ca—S | 160 | 0.50 | MMP | 180 | ⊚ | ⊚ | ⊚ |
| 12 | | | | | | | | | |
| EMB | ER | Al—S | 165 | 0.50 | BR | 180 | ⊚ | ⊚ | ⊚ |
| 13 | | | | | | | | | |
| EMB | ER | Al—S | 165 | 0.50 | BR | 180 | ⊚ | ⊚ | ⊚ |
| 14 | | | | | | | | | |

As shown in Table 1, all embodiments show the marks “⊚” or “◯,” they are all excellent for an electronic component. In contrast, all comparative examples show “bad” results so that they are not appropriate for an electronic component. With respect to Table 1, the followings are specific comments.

### Comparative Examples 1 and 3

In regards to the comparative examples 1 and 3, because the organic metallic soap is not included, the mark “X” is shown in a data item of “a rust prevention” (according to the result of the salt water spray test, rust is generated).

### Comparative Examples 1-1 and 11-1/Embodiments 1-1 to 1-8 and 11-1 to 11-8

In regards to the comparative examples 1-1 and 11-1, because the content of the organic metallic soap is small, the mark “X” is shown in the data item of “the rust prevention.”

In contrast, with respect to the embodiments 1-1 to 1-8 and 11-1 to 11-8, because the content of the organic metallic soap is in an appropriate range (more than 0.01 wt % and less than 2.00 wt %), the organic metallic soaps were melted during thermosetting so that the part that was not coated with the binder resin of the metal powder could surely be coated by the organic metallic soap. Therefore, rust was not generated.

### Comparative Examples 1-2 and 11-2/Embodiments 1-1 to 1-8 and 11-1 to 11-8

In regards to the comparative examples 1-2 and 11-2, because the content of the organic metallic soap is large, the strength of the composite material is insufficient so that the mark “X” is shown in the data item of “the rust prevention.”

In contrast, with respect to the embodiments 1-1 to 1-8 and 11-1 to 11-8, because the content of the organic metallic soap is in an appropriate range (more than 0.01 wt % and less than 2.00 wt %), the organic metallic soaps were melted during thermosetting so that the part that was not coated with the binder resin of the metal powder could surely be coated by the organic metallic soap. Therefore, rust was not generated.

### Comparative Examples 4-1, 5-1, and 6-1/Embodiments 4-1, 5-1, and 6-1

In regards to the comparative example 4-1, because the melting point (160° C.) of the added organic metallic soap was higher than the thermosetting temperature (150° C.), the organic metallic soap was not melted during thermosetting so that the part that was not coated with the binder resin of the metal powder could not also be coated by the organic metallic soap. Therefore, the mark “X” is shown in the data item of “the rust prevention”.

Further, in regards to the comparative example 5-1, because the melting point (155° C.) of the added organic metallic soap was higher than the thermosetting temperature (150° C.), the organic metallic soap was not melted during thermosetting so that the part that was not coated with the binder resin of the metal powder could not also be coated by the organic metallic soap. Therefore, the mark “X” is shown in the data item of “the rust prevention”.

Lastly, in regards to the comparative example 6-1, because the melting point (165° C.) of the added organic metallic soap was higher than the thermosetting temperature (150° C.), the organic metallic soap was not melted during thermosetting so that the part that was not coated with the binder resin of the metal powder could not be coated by the organic metallic soap. Therefore, the mark “X” is shown in the data item of “the rust prevention”.

In contrast, with respect to the embodiments 4-1, 5-1 and 6-1, because the thermosetting temperatures (180° C.) are higher than the respective organic metallic soaps' melting points (160° C., 155° C., and 165° C.), respectively, the organic metallic soaps were melted during thermosetting so that the part that was not coated with the binder resin of the metal powder could surely be coated by the organic metallic soap. Therefore, rust was not generated.

### Comparative Examples 2 and 4/Embodiments 1-1 to 1-8 and 11-1 to 11-8

In regards to the comparative example 2, because the melting point (220° C.) of the added organic metallic soap was higher than the thermosetting temperature (180° C.) of the epoxy resin, the organic metallic soap was not melted during thermosetting so that the part that was not coated with the binder resin of the metal powder could not be coated by the organic metallic soap. Therefore, the mark “X” is shown in the data item of “a rust prevention”.

In regards to the comparative example 4, in the same way as in the comparative example 2, because the melting point (220° C.) of the added organic metallic soap was higher than the thermosetting temperature (200° C.) of the silicone resin, the organic metallic soap was not melted during thermosetting so that the part that was not coated with the binder resin of the metal powder could not be coated by the organic metallic soap. Therefore, the mark “X” is shown in the data item of “a rust prevention”.

In contrast, with respect to the embodiments 1-1 to 1-8, because the melting point (140° C.) of the added organic metallic soap was lower than the thermosetting temperature (180° C.) of the epoxy resin, the organic metallic soaps were melted during thermosetting so that the part that was not coated with the binder resin of the metal powder could surely be coated by the organic metallic soap. Therefore, rust was not generated.

In contrast, with respect to the embodiments 11-1 to 11-8, because the melting point (165° C.) of the added organic metallic soap was lower than the thermosetting temperature (200° C.) of the silicone resin, the organic metallic soaps were melted during thermosetting so that the part that was not coated with the binder resin of the metal powder could surely be coated by the organic metallic soap. Therefore, rust was not generated.

As shown in Table 1, the embodiments 2, 4, 7-10, and 12-14 are also excellent in both the rust prevention and the strength of the magnetic heat-cured body because an organic metallic soap having an appropriate melting temperature and amount is included in the composite magnetic material, and appropriate thermosetting temperature (heat treatment or heat curing temperature) is selected as discussed in the embodiments.

The composite magnetic material, the composite magnetic molded body that is obtained by molding the composite magnetic material, the composite heat-cured body that is obtained by heat curing the composite magnetic molded body, the electronic component that is obtained by using the composite magnetic molded (heat cured) body, and the method thereof being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

What is claimed is:

1. A composite magnetic material comprising:
a metal magnetic powder;
a binder resin; and
a metallic soap,
wherein a melting point of the metallic soap is equal to or lower than a thermosetting temperature of the binder resin, and
0.01 wt %<(wt % of the metallic soap)/(wt % of the metallic soap+wt % of the metal magnetic powder+wt % of the binder resin)×100<2.0 wt %.

2. A composite magnetic heat-cured body comprising:
a metal magnetic powder;
a binder resin; and
a metallic soap,
wherein the metallic soap and the binder completely cover an entire surface of the metal magnetic powder,
wherein a melting point of the metallic soap is equal to or lower than a thermosetting temperature of the binder resin, and
0.01 wt %<(wt % of the metallic soap)/(wt % of the metallic soap+wt % of the metal magnetic powder+wt % of the binder resin)×100<2.0 wt %.

3. The composite magnetic heat-cured body according to claim 2 further comprising:
an element embedded into the composite magnetic heat-cured body to form an electronic component.

4. The composite magnetic heat-cured body according to claim 3,
wherein the element is a coil.

5. A method for manufacturing an electronic component comprising:
preparing a composite magnetic material by mixing a metal magnetic powder, a binder resin, and a metallic soap,
wherein 0.01 wt %<(wt % of the metallic soap)/(wt % of the metallic soap+wt % of the metal magnetic powder+wt % of the binder resin)×100<2.0 wt %;
preparing a composite magnetic molded body by molding the composite magnetic material and by embedding an element in the composite magnetic material so that the element is embedded into the composite magnetic molded body; and
curing the composite magnetic molded body at a temperature higher than a melting point of the metallic soap,
wherein after the metallic soap is melted by the curing, the metallic soap is solidified, and
the cured binder resin and the solidified metallic soap completely cover an entire surface of the metal magnetic powder.

6. The method for manufacturing an electronic component according to claim 5 wherein said preparing of the composite magnetic molded body further comprises:
molding the composite magnetic material in a mold and embedding the element in the composite magnetic material in the mold.

7. The method for manufacturing an electronic component according to claim 5 wherein said preparing the composite magnetic material by mixing further comprises:
mixing the metal magnetic powder, the binder resin, the metallic soap, and a plasticizer.

8. The method for manufacturing an electronic component according to claim 6 wherein said preparing the composite magnetic material by mixing further comprises:
mixing the metal magnetic powder, the binder resin, the metallic soap, and a plasticizer.

9. The method for manufacturing an electronic component according to claim 5 wherein the preparing the composite magnetic material by mixing further comprises:
mixing the metal magnetic powder, the binder resin, the metallic soap, and a solvent.

10. The method for manufacturing an electronic component according to claim 6 wherein the preparing the composite magnetic material by mixing further comprises:
mixing the metal magnetic powder, the binder resin, the metallic soap, and a solvent.
